(19) United States
(12) Patent Application Publication
(10) Pub. No.: US 2010/0193405 A1
(43) Pub. Date: Aug. 5, 2010

(54) Method for sorting nanoobjects and an apparatus fabricated thereby

(76) Inventor: Vladimir Y. Butko, St. Petersburg (RU)

Correspondence Address: Vladimir Y. Butko, 1-3-30 Cofii Kobalebckoi, St. Petersburg, 195252, omitted

(21) Appl. No.: 12/690,873

(22) Filed: Jan. 20, 2010

(30) Foreign Application Priority Data
Feb. 3, 2009 (RU) 2009103926

(51) Int. Cl. B07C 5/344; H01B 1/00; B07C 5/02

(52) U.S. Cl. 209/3.1; 252/500; 977/742

(57) ABSTRACT

A method for sorting nanoobjects from the mixture comprising nanoobjects such as semiconducting and metallic carbon nanotubes and an apparatus fabricated thereby. An embodiment comprises an energy transfer to the mixture in a way that the degree in which nanoonobjects are heated and bonded to the surface of a substance depends on their electrical conductivities. The next embodiment comprises an electrolytic deposition of a material on the mixture in a way that the degree in which nanoanobjects are bonded to the surface of the substance by the deposited layer depends on their electrical conductivities. The above nanoobjects are sorted by selectively separating mostly the weaker bonded nanoobjects from the surface. Another embodiment comprises an energy transfer in a low pressure reactive gas medium to the mixture in a way that the degree in which nanoonobjects are heated and chemically modified depends on their conductivities.

### CROSS REFERENCE TO RELATED APPLICATIONS

### Related Applications May be Listed on an Application Data Sheet, Either Instead of or Together with being Listed in the Specification

The priority date for this patent Application should be established on the basis of the priority date of the “parent” Russian Patent Application 2009103926 filed at the Federal Institute of Industrial Property (Russian Patent Office) on Feb. 3, 2009.

Other references:
1) U.S. Pat. No. 6,423,583 Jul. 23, 2002
2) US Patent Application 20060065887
3) U.S. Pat. No. 7,150,865 Dec. 19, 2006
4) US Patent Application 20070085460
5) US Patent Application 20060278579
6) US Patent Application 20040173378

### STATEMENT OF FEDERALLY SPONSORED RESEARCH/DEVELOPMENT (IF ANY)

### REFERENCE TO A “SEQUENCE LISTING,”

None

### BACKGROUND OF THE INVENTION

Nanoobjects (objects with at least one spatial size in the range from 0.05 nm to 500 nm), including carbon nanotubes demonstrate a number of unique properties, and are potentially important for industrial applications. Potential applications of the carbon nanotubes includes: field effect transistors, bipolar transistors, solar cells, lasers, light emitting diodes, photodiodes, electron sources, devices for transforming and radiating electromagnetic fields, electrical sources, capacitors, devices for surface studies, computer related devices, devices for hydrogen storage, monitors, flexible electronic and optoelectronic devices, electrical and thermal contacts and others. However, to realize the full potential of carbon nanotubes methods that are capable of obtaining large quantities of them with uniform physical and chemical properties are required. This problem has not been solved in previous studies. Methods that have been proposed to solve this problem include the following: Destroying metallic nanotubes by electrical current [1-2] (U.S. Pat. No. 6,423,583 Jul. 23, 2002, US Patent Application 20060065887), destroying metallic nanotubes by microwave radiation in air [3-4] (U.S. Pat. No. 7,150,865 Dec. 19, 2006 and US patent application 20070085460), and by selectively plating the metallic carbon nanotubes to precipitate the metallic carbon nanotubes from the solutions (US patent applications 20060278579, 20040173378). One of the main disadvantages of the first two methods is the high temperatures required in these methods. The high temperature results in a big damage to almost all nanoobjects in the process. The main disadvantage of the third method is the low efficiency of this process and a requirement of using an electroless plating solution for precipitation.

### BRIEF SUMMARY OF THE INVENTION

This invention is related to nanothechnology and more precisely to methods for sorting nanoobjects, such as semiconducting and metallic nanotubes. The method claimed here fundamentally does not have the mentioned disadvantages and opens new opportunities in solving the problem of sorting nanoobjects with different electrical conductivities. There are three general embodiments of this invention. The first general embodiment comprises an energy transfer to the mixture in a way that the degree in which nanoonobjects are heated and bonded to the surface of a substance depends on their conductivities. The second general embodiment comprises an electrolytic deposition of a material on the mixture, using a contact to the conducting surface in a way that the degree in which nanoanobjects are bonded to the surface of the substance by the deposited layer depends on their electrical conductivities. The above nanoobjects are sorted by selective separating mostly the weaker bonded nanoobjects and non-bonded nanoobjects from the surface. The third embodiment comprises an energy transfer in a low pressure reactive gas medium to the mixture of the nanoobjects in a way that the degree in which nanoonobjects are heated and chemically modified depends on their electrical conductivities.

### BRIEF DESCRIPTION OF THE SEVERAL VIEWS OF THE DRAWING (IF ANY)

FIG. 1 depicts a method according to the first general embodiment of the present invention.

FIG. 2 depicts a method according to the second general embodiment of the present invention.

FIG. 3 depicts a method according to the third general embodiment of the present invention.

### DETAILED DESCRIPTION OF THE INVENTION

Embodiments of the present invention are now described with reference to the accompanying figures.

The present invention is described more fully hereinafter with reference to the accompanying drawings, in which example embodiments of the present invention are shown. The present invention may, however, be embodied in many different forms and should not be construed as limited to the embodiments set forth herein. Rather, these example embodiments are provided so that this disclosure will be thorough and complete, and will fully convey the scope of the present invention to those skilled in the art. In the drawings, the sizes and/or relative sizes of layers and/or regions may be exaggerated for clarity.

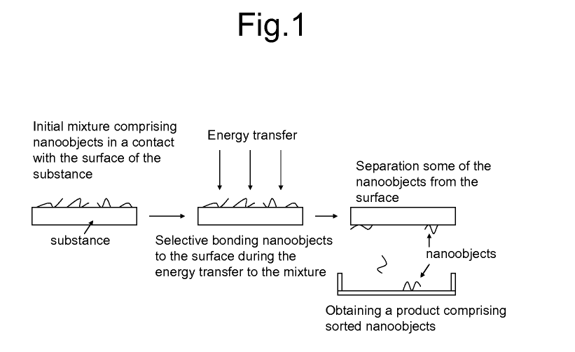

A. The first general embodiment is illustrated in the FIG. 1.

This embodiment describes a method for sorting nanoobjects (objects with at least one spatial size in the range from 0.05 nm to 500 nm), comprising the steps of: a) providing contact between an initial mixture that comprises the nanoobjects with different electrical conductivities and a surface of a substance selected from the group consisting of: a solid, a liquid, a soft matter, and any combinations thereof; b) providing an energy transfer to the said mixture with an amount of heat per unit of time obtained by the nanoonobjects dependent on their electrical conductivities at least until some of the nanoonobjects are bonded to the surface with an average strength of this bonding dependent on the nanoobjects electrical conductivities; c) selectively separating mostly the weaker bonded and non-bonded nanoobjects from the surface; and d) obtaining at least one product that comprises the nanoobjects with an average electrical conductivity that is different from the average electrical conductivity of the nanoobjects in the initial mixture.

The first general embodiment includes the following examples:

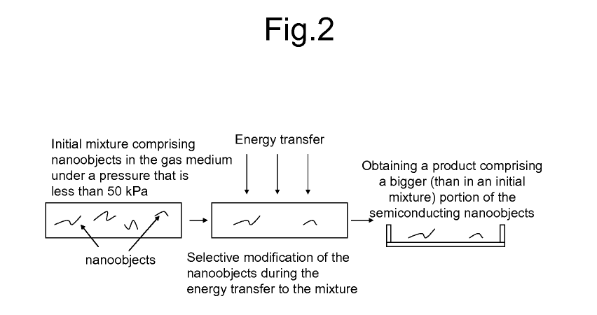

(1) The method, wherein the mixture comprises at least one semiconducting carbon nanotube.
(2) The method, further comprising the steps of: providing a purification of the mixture from metallic inclusions, providing at least a partial separation of the stacked together carbon nanotubes, and providing the contact between the mixture that contains nanoobjects and the surface of the substance by at least one of the means selected from the group consisting of: a mechanical force, a gravitational force, and an inertial force.
(3) The method, wherein at least some part of the substance for at least some (nonzero) period of time during the energy transfer is kept at a temperature such that the difference between this temperature and at least one temperature selected from the group consisting of: a melting transition temperature of a part of the substance, an evaporation transition temperature of a part of the substance, an activation temperature of a chemical reaction that involves a part of the substance, an activation temperature of a chemical reaction that involves the nanoobjects, is less than a maximal difference between temperatures of any parts of the nanoobjects at the surface during energy transfer.
(4) The method, wherein at least some part of the substance for at least some (nonzero) period of time during the energy transfer is kept at a temperature such that the difference between this temperature and at least one temperature selected from the group consisting of: a melting transition temperature of a part of the substance, and an evaporation transition temperature of a part of the substance, is less than a maximal difference between temperatures of any parts of the carbon nanotubes during energy transfer, and at least some part of the substance during the energy transfer at least one time changes its phase from one phase from the group consisting of: a solid phase, a liquid phase, and a vapor phase, to another phase from the same group.
(5) The method, wherein the surface of the substance has a shape with a high ratio (≧1.5) of the surface area to the surface area of a flat geometrical figure with the same overall length and width.
(6) The method, wherein the energy transfer at least includes an electromagnetic radiation in the frequency range from 100 MHz to 400 THz.
(7) The method, wherein the energy transfer at least includes transferring energy in a form selected from the group consisting of: a microwave electromagnetic radiation, and a far infrared electromagnetic radiation.
(8) The method, wherein the separation of the weaker bonded and non-bonded nanoobjects from the surface is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof.
(9) The method, wherein the energy transfer at least includes transferring energy by a narrow bandwidth electromagnetic radiation with a photon energy at the edge of resonance electron transitions in the nanoobjects in the frequency range from 100 MHz to 400 THz.
(10) The method, wherein the energy transfer at least includes transferring energy in a form selected from the group consisting of: an electromagnetic radiation in the frequency range from 100 MHz to 400 THz, an energy transfer from an electrical source by a direct electrical current that provides heat, an energy transfer from an electrical source by an alternating electrical current that provides heat, and any combinations thereof.
(11) The method of claim 1, wherein the energy transfer at least includes transferring energy from an electrical source by an electrical current selected from the group consisting of: a direct current that provides heat, an alternating current that provides heat, and any combinations thereof.
(12) The method of claim 2, wherein the weaker bonded carbon nanotubes and non-bonded carbon nanotubes comprises a bigger than average portion of the semiconducting carbon nanotubes.
B. The second general embodiment is illustrated in the FIG. 2.

This embodiment describes a method for increasing the portion of semiconducting nanoobjects in a mixture that comprises nanoobjects (objects with at least one spatial size in the range from 0.05 nm to 500 nm) with different electrical conductivities, comprising the steps of: a) providing a placement of an initial mixture that comprises the nanoobjects with different electrical conductivities into a gas medium under the pressure that is significantly lower than the normal atmospheric pressure (the pressure is less than 50 kPa); b) providing an energy transfer to the said mixture with an amount of heat per unit of time obtained by the nanoobjects dependent on their electrical conductivities at least until some of the nanoonobjects are modified into a form from the group consisting of: a gas, a liquid, a semiconductor, an insulator, and any combinations thereof; and c) obtaining at least one product that comprises the nanoobjects with a portion of the semiconducting nanoobjects that is significantly bigger than the portion of the semiconducting nanoobjects in the initial mixture.

The second general embodiment includes the following examples:

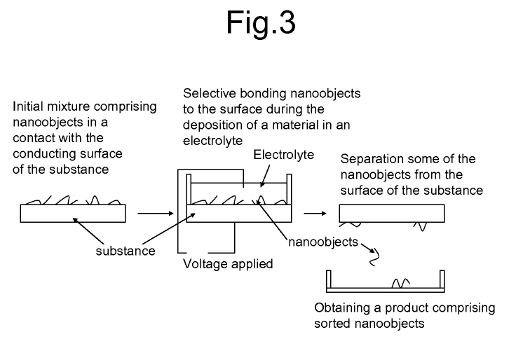

(1) The method, wherein the mixture comprises at least one semiconducting carbon nanotube.
(2) The method, further comprising the steps of: providing a purification of the mixture from metallic inclusions, and providing at least a partial separation of the stacked together carbon nanotubes.
(3) The method, wherein the gas medium comprises at least one gas from the group consisting of: an oxygen gas (O₂), an ozone gas (O₃), a fluorine gas (F₂), an oxidizing agent gas, and any combinations thereof, with a partial pressure that is at least by 10% higher than the partial pressure of this gas in air.
(4) The method, wherein at least some part of the gas medium for at least some (nonzero) period of time during the energy transfer is kept at a temperature such that the difference between this temperature and an activation temperature of a chemical reaction that involves the nanoobjects and the gas medium is less than a maximal difference between temperatures of any parts of the nanoobjects during energy transfer.
(5) The method, wherein the energy transfer at least includes an electromagnetic radiation in the frequency range from 100 MHz to 400 THz.
(6) The method, wherein the energy transfer at least includes transferring energy by a narrow bandwidth electromagnetic radiation with a photon energy at the edge of resonance electron transitions in the nanoobjects in the frequency range from 100 MHz to 400 THz.
(7) The method, wherein the energy transfer at least includes transferring energy from an electrical source by an electrical current selected from the group consisting of: a direct current that provides heat, an alternating current that provides heat, and any combinations thereof.
C. The third general embodiment is illustrated in the FIG. 3.

This embodiment describes a method for sorting nanoobjects (objects with at least one spatial size in the range from 0.05 nm to 500 nm), comprising the steps of: a) providing a contact between an initial mixture that comprises the nanoobjects with different electrical conductivities and a electrical conducting surface of a substance selected from the group consisting of: a solid, a liquid, a soft matter, and any combinations thereof; b) providing a deposition of a material in an electrolyte while driving an electrical current through the said contact at least during some (nonzero) period of time during this deposition with a thickness of the material layer deposited per unit of time on the nanoonobjects dependent on their electrical conductivities until at least some of the nanoonobjects are bonded to the surface with an average strength of this bonding dependent on the nanoobjects electrical conductivities; c) selectively separating mostly the weaker bonded and non-bonded nanoobjects from the surface; and d) obtaining at least one product that comprises the nanoobjects with an average electrical conductivity that is different from the average electrical conductivity of the nanoobjects in the initial mixture.

The third general embodiment includes the following examples:

(1) The method, wherein the mixture comprises at least one semiconducting carbon nanotube.
(2) The method, further comprising the steps of: providing the fixed contact by at least one of the means selected from the group consisting of: a mechanical force, a gravitational force, and an inertial force.
(3) The method, wherein the electrical conducting surface, the material, and the electrolyte comprises at least one chemical element from the group consisting of: a alkali metal, an alkaline earth metal, C, H, Si, As, Ga, In, Sb, Cu, Au, Pd, Pt, Ag, Al, Ni, Co, Fe, Sn, Zn, Hg, Pb, and any combinations thereof.
(4) The method, wherein the conducting surface of the substance has a shape with a high ratio (≧1.5) of the surface area to the surface area of a flat geometrical figure with the same overall length and width.
(5) The method, wherein the deposition of the material comprises an electroplating deposition with providing an electrical potential difference in the electrolyte between at least some (nonzero) part of the mixture and at least one other electrode in the electrolyte.
(6) The method, wherein the separation of the weaker bonded and non-bonded nanoobjects from the surface is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof.
(7) The method, wherein the weaker bonded carbon nanotubes and non-bonded carbon nanotubes comprises a bigger than average portion of the semiconducting carbon nanotubes.

It will be understood that, although the terms first, second, third etc. may be used herein to describe the embodiments these terms are only used for to illustrative purposes.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein with reference to figures that are schematic illustrations of idealized embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, a region illustrated as a rectangle will, typically, have rounded or curved features and/or a gradient. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although example embodiments of the present invention have been disclosed for illustrative purposes, those skilled in the art will appreciate that various modifications, additions and substitutions are possible, without departing from the scope and spirit of the invention as disclosed in the accompanying claims.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

We claim:

1. A method for sorting nanoobjects (objects with at least one spatial size in the range from 0.05 nm to 500 nm), comprising the steps of: a) providing contact between an initial mixture that comprises the nanoobjects with different electrical conductivities and a surface of a substance selected from the group consisting of: a solid, a liquid, a soft matter, and any combinations thereof; b) providing an energy transfer to the said mixture with an amount of heat per unit of time obtained by the nanoonobjects dependent on their electrical conductivities at least until some of the nanoonobjects are bonded to the surface with an average strength of this bonding dependent on the nanoobjects electrical conductivities; c) selectively separating mostly the weaker bonded and non-bonded nanoobjects from the surface; and d) obtaining at least one product that comprises the nanoobjects with an average electrical conductivity that is different from the average electrical conductivity of the nanoobjects in the initial mixture.

2. The method of claim 1, wherein the mixture comprises at least one semiconducting carbon nanotube.

3. The method of claim 2, further comprising the steps of: providing a purification of the mixture from metallic inclusions, providing at least a partial separation of the stacked together carbon nanotubes, and providing the contact between the mixture that contains nanoobjects and the surface of the substance by at least one of the means selected from the group consisting of: a mechanical force, a gravitational force, and an inertial force.

4. The method of claim 1, wherein at least some part of the substance for at least some (nonzero) period of time during the energy transfer is kept at a temperature such that the difference between this temperature and at least one temperature selected from the group consisting of: a melting transition temperature of a part of the substance, an evaporation transition temperature of a part of the substance, an activation temperature of a chemical reaction that involves a part of the substance, an activation temperature of a chemical reaction that involves the nanoobjects, is less than a maximal difference between temperatures of any parts of the nanoobjects at the surface during energy transfer.

5. The method of claim 2, wherein at least some part of the substance for at least some (nonzero) period of time during the energy transfer is kept at a temperature such that the difference between this temperature and at least one temperature selected from the group consisting of: a melting transition temperature of a part of the substance, and an evaporation transition temperature of a part of the substance, is less than a maximal difference between temperatures of any parts of the carbon nanotubes during energy transfer, and at least some part of the substance during the energy transfer at least one time changes its phase from one phase from the group consisting of: a solid phase, a liquid phase, and a vapor phase, to another phase from the same group.

6. The method of claim 2, wherein the surface of the substance has a shape with a high ratio (≧1.5) of the surface area to the surface area of a flat geometrical figure with the same overall length and width.

7. The method of claim 1, wherein the energy transfer at least includes an electromagnetic radiation in the frequency range from 100 MHz to 400 THz.

8. The method of claim 2, wherein the energy transfer at least includes transferring energy in a form selected from the group consisting of: a microwave electromagnetic radiation, and a far infrared electromagnetic radiation.

9. The method of claim 2, wherein the separation of the weaker bonded and non-bonded nanoobjects from the surface is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof.

10. The method of claim 1, wherein the energy transfer at least includes transferring energy by a narrow bandwidth electromagnetic radiation with a photon energy at the edge of resonance electron transitions in the nanoobjects in the frequency range from 100 MHz to 400 THz.

11. The method of claim 5, wherein the energy transfer at least includes transferring energy in a form selected from the group consisting of: an electromagnetic radiation in the frequency range from 100 MHz to 400 THz, an energy transfer from an electrical source by a direct electrical current that provides heat, an energy transfer from an electrical source by an alternating electrical current that provides heat, and any combinations thereof.

12. The method of claim 1, wherein the energy transfer at least includes transferring energy from an electrical source by an electrical current selected from the group consisting of: a direct current that provides heat, an alternating current that provides heat, and any combinations thereof.

13. The method of claim 2, wherein the weaker bonded carbon nanotubes and non-bonded carbon nanotubes comprises a bigger than average portion of the semiconducting carbon nanotubes.

14. An apparatus, comprising at least one device from the group consisting of:
i) a field effect transistor, a bipolar transistor, a solar cell, a laser, a light emitting diode, a photodiode, an electron source, a device for transforming and radiating electromagnetic fields, an electrical source, a capacitor, a device for surface studies, a computer related device, a device for hydrogen storage, a monitor, a flexible electronic device, a flexible optoelectronic device, an electrical connector, and a thermal connector, comprising any nanoobjects from the product obtained by the method of claim 1; and
ii) a device for sorting nanoobjects, comprising a) a substance selected from the group consisting of: a solid, a liquid, a soft matter, and any combinations thereof; b) a component providing contact between the surface of the said substance and an initial mixture that comprises nanoobjects with different electrical conductivities; c) a component providing an energy transfer to the said mixture with an amount of heat per unit of time obtained by the nanoonobjects dependent on their electrical conductivities at least until some of the nanoonobjects are bonded to the surface with an average strength of this bonding dependent on the nanoobjects electrical conductivities; d) a component providing a selective separation of mostly the weaker bonded and non-bonded nanoobjects from the said surface; and e) a component obtaining at least one product that comprises the nanoobjects with an average electrical conductivity that is different from the average electrical conductivity of the nanoobjects in the initial mixture.

15. The apparatus of claim 14, wherein the mixture comprises at least one semiconducting carbon nanotube.

16. The apparatus of claim 15, wherein
i) the method further comprising the steps of: providing a purification of the mixture from metallic inclusions, providing at least a partial separation of the stacked together carbon nanotubes, and providing the contact between the mixture that contains nanoobjects and the surface of the substance by at least one of the means selected from the group consisting of: a mechanical force, a gravitational force, an inertial force; and
ii) the device for sorting nanoobjects, that further comprises: a component providing a purification of the mixture from metallic inclusions, a component providing at least a partial separation of the stacked together carbon nanotubes, and a component providing the contact between the mixture that contains nanoobjects and the surface of the substance by at least one of the means selected from the group consisting of: a mechanical force, a gravitational force, an inertial force.

17. The apparatus of claim 14, wherein
i) the method further comprises that at least some part of the substance for at least some (nonzero) period of time during the energy transfer is kept at a temperature such that the difference between this temperature and at least one temperature selected from the group consisting of: a melting transition temperature of a part of the substance, an evaporation transition temperature of a part of the substance, an activation temperature of a chemical reaction that involves a part of the substance, an activation temperature of a chemical reaction that involves the nanoobjects, is less than a maximal difference between temperatures of any parts of the nanoobjects at the surface during energy transfer; and
ii) the device for sorting nanoobjects that further comprises: a component providing that at least some part of the substance for at least some (nonzero) period of time during the energy transfer is kept at a temperature such that the difference between this temperature and at least one temperature selected from the group consisting of: a melting transition temperature of a part of the substance, an evaporation transition temperature of a part of the substance, an activation temperature of a chemical reaction that involves a part of the substance, an activation temperature of a chemical reaction that involves the nanoobjects, is less than a maximal difference between temperatures of any parts of the nanoobjects at the surface during energy transfer.

18. The apparatus of claim 15, wherein
i) the method further comprises that at least some part of the substance for at least some (nonzero) period of time during the energy transfer is kept at a temperature such that the difference between this temperature and at least one temperature selected from the group consisting of: a melting transition temperature of a part of the substance, and an evaporation transition temperature of a part of the substance, is less than a maximal difference between temperatures of any parts of the carbon nanotubes during energy transfer, and at least some part of the substance during the energy transfer at least one time changes its phase from one phase from the group consisting of: a solid phase, a liquid phase, and a vapor phase, to another phase from the same group; and
ii) the device for sorting nanoobjects, that further comprises: a component providing that at least some part of the substance for at least some (nonzero) period of time during the energy transfer is kept at a temperature such that the difference between this temperature and at least one temperature selected from the group consisting of: a melting transition temperature of a part of the substance, and an evaporation transition temperature of a part of the substance, is less than a maximal difference between temperatures of any parts of the carbon nanotubes during energy transfer, and that at least some part of the substance during the energy transfer at least one time changes its phase from one phase from the group consisting of: a solid phase, a liquid phase, and a vapor phase, to another phase from the same group.

19. The apparatus of claim 15, wherein
i) the method further comprises that the surface of the substance has a shape with a high ratio (≧1.5) of the surface area to the surface area of a flat geometrical figure with the same overall length and width;
ii) the device for sorting nanoobjects, further comprising: a substance that has a shape with a high ratio (≧1.5) of the surface area to the surface area of a flat geometrical figure with the same overall length and width.

20. The apparatus of claim 14, wherein
i) the method further comprises that the energy transfer at least includes an electromagnetic radiation in the frequency range from 100 MHz to 400 THz; and
ii) the device for sorting nanoobjects, that further comprises: a component providing the energy transfer that at least includes an electromagnetic radiation in the frequency range from 100 MHz to 400 THz.

21. The apparatus of claim 15, wherein
i) the method further comprises that the energy transfer at least includes transferring energy in a form selected from the group consisting of: a microwave electromagnetic radiation, and a far infrared electromagnetic radiation; and
ii) the device for sorting nanoobjects, that further comprises: a component providing the energy transfer that at least includes transferring energy in a form selected from the group consisting of: a microwave electromagnetic radiation, and a far infrared electromagnetic radiation.

22. The apparatus of claim 15, wherein
i) the method further comprises that the separation of the weaker bonded and non-bonded nanoobjects from the surface is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof and
ii) the method further comprises that the device for sorting nanoobjects, further comprises: a component providing the separation of the weaker bonded and non-bonded nanoobjects from the surface that is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof.

23. The apparatus of claim 14, wherein
i) the method further comprises that the energy transfer at least includes transferring energy by a narrow bandwidth electromagnetic radiation with a photon energy at the edge of resonance electron transitions in the nanoobjects in the frequency range from 100 MHz to 400 THz;
ii) the device for sorting nanoobjects, that further comprises: a component providing the energy transfer that at least includes transferring energy by a narrow bandwidth electromagnetic radiation with a photon energy at the edge of resonance electron transitions in the nanoobjects in the frequency range from 100 MHz to 400 THz.

24. The apparatus of claim 18, wherein
i) the method further comprises that the energy transfer at least includes transferring energy in a form selected from the group consisting of: an electromagnetic radiation in the frequency range from 100 MHz to 400 THz, an energy transfer from an electrical source by a direct electrical current that provides heat, an energy transfer from an electrical source by an alternating electrical current that provides heat, and any combinations thereof
ii) the device for sorting nanoobjects, that further comprises: a component providing the energy transfer that at least includes transferring energy in a form selected from the group consisting of: an electromagnetic radiation in the frequency range from 100 MHz to 400 THz, an energy transfer from an electrical source by a direct electrical current that provides heat, an energy transfer from an electrical source by an alternating electrical current that provides heat, and any combinations thereof.

25. The apparatus of claim 14, wherein
i) the method further comprises that the energy transfer at least includes transferring energy from an electrical source by an electrical current selected from the group consisting of: a direct current that provides heat, an alternating current that provides heat, and any combinations thereof;
ii) the device for sorting nanoobjects, that further comprises: a component providing the energy transfer that at least includes transferring energy from an electrical source by an electrical current selected from the group consisting of: a direct current that provides heat, an alternating current that provides heat, and any combinations thereof.

26. The apparatus of claim 15, wherein
i) the method further comprises that the weaker bonded carbon nanotubes and non-bonded carbon nanotubes comprises a bigger than average portion of the semiconducting carbon nanotubes;
ii) the device for sorting nanoobjects, that further comprises: a component providing that the weaker bonded carbon nanotubes and non-bonded carbon nanotubes comprises a bigger than average portion of the semiconducting carbon nanotubes.

27. A method for increasing the portion of semiconducting nanoobjects in a mixture that comprises nanoobjects (objects with at least one spatial size in the range from 0.05 nm to 500 nm) with different electrical conductivities, comprising the steps of: a) providing a placement of an initial mixture that comprises the nanoobjects with different electrical conductivities into a gas medium under the pressure that is significantly lower than the normal atmospheric pressure (the pressure is less than 50 kPa); b) providing an energy transfer to the said mixture with an amount of heat per unit of time obtained by the nanoobjects dependent on their electrical conductivities at least until some of the nanoonobjects are modified into a form from the group consisting of: a gas, a liquid, a semiconductor, an insulator, and any combinations thereof; and c) obtaining at least one product that comprises the nanoobjects with a portion of the semiconducting nanoobjects that is significantly bigger than the portion of the semiconducting nanoobjects in the initial mixture.

28. The method of claim 27, wherein the mixture comprises at least one semiconducting carbon nanotube.

29. The method of claim 28, further comprising the steps of: providing a purification of the mixture from metallic inclusions, and providing at least a partial separation of the stacked together carbon nanotubes.

30. The method of claim 28, wherein the gas medium comprises at least one gas from the group consisting of: an oxygen gas (O₂), an ozone gas (O₃), a fluorine gas (F₂), an oxidizing agent gas, and any combinations thereof, with a partial pressure that is at least by 10% higher than the partial pressure of this gas in air.

31. The method of claim 28, wherein at least some part of the gas medium for at least some (nonzero) period of time during the energy transfer is kept at a temperature such that the difference between this temperature and an activation temperature of a chemical reaction that involves the nanoobjects and the gas medium is less than a maximal difference between temperatures of any parts of the nanoobjects during energy transfer.

32. The method of claim 28, wherein the energy transfer at least includes an electromagnetic radiation in the frequency range from 100 MHz to 400 THz.

33. The method of claim 27, wherein the energy transfer at least includes transferring energy by a narrow bandwidth electromagnetic radiation with a photon energy at the edge of resonance electron transitions in the nanoobjects in the frequency range from 100 MHz to 400 THz.

34. The method of claim 28, wherein the energy transfer at least includes transferring energy from an electrical source by an electrical current selected from the group consisting of: a direct current that provides heat, an alternating current that provides heat, and any combinations thereof.

35. An apparatus, comprising at least one device from the group consisting of:
i) a field effect transistor, a bipolar transistor, a solar cell, a laser, a light emitting diode, a photodiode, an electron source, a device for transforming and radiating electromagnetic fields, an electrical source, a capacitor, a device for surface studies, a computer related device, a device for hydrogen storage, a monitor, a flexible electronic device, a flexible optoelectronic device, an electrical connector, and a thermal connector, comprising any nanoobjects from the product obtained by the method of claim 27; and
ii) a device for sorting nanoobjects, comprising a) a component providing a placement of an initial mixture that comprises the nanoobjects with different electrical conductivities into a gas medium under the pressure that is significantly lower than the normal atmospheric pressure (the pressure is less than 50 kPa); b) a component providing an energy transfer to the said mixture with an amount of heat per unit of time obtained by the nanoobjects dependent on their electrical conductivities at least until some of the nanoonobjects are modified into a form from the group consisting of: a gas, a liquid, a semiconductor, an insulator, and any combinations thereof; c) a component obtaining at least one product that comprises the nanoobjects with a portion of the semiconducting nanoobjects that is significantly bigger than the portion of the semiconducting nanoobjects in the initial mixture.

36. The apparatus of claim 27, wherein the mixture comprises at least one semiconducting carbon nanotube.

37. The apparatus of claim 28, wherein
i) the method further comprises the steps of: providing a purification of the mixture from metallic inclusions, and providing at least a partial separation of the stacked together carbon nanotubes;
ii) the device for sorting nanoobjects, that further comprises: a component providing a purification of the mixture from metallic inclusions, and providing at least a partial separation of the stacked together carbon nanotubes.

38. The apparatus of claim 28, wherein
i) the method further comprises the gas medium that comprises at least one gas from the group consisting of: an oxygen gas (O₂), an ozone gas (O₃), a fluorine gas (F₂), an oxidizing agent gas, and any combinations thereof, with a partial pressure that is at least by 10% higher than the partial pressure of this gas in air;
ii) the device for sorting nanoobjects, further comprises: the gas medium that comprises at least one gas from the group consisting of: an oxygen gas (O₂), an ozone gas (O₃), a fluorine gas (F₂), an oxidizing agent gas, and any combinations thereof, with a partial pressure that is at least by 10% higher than the partial pressure of this gas in air

39. The apparatus of claim 28, wherein
i) the method further comprises at least some part of the gas medium that for at least some (nonzero) period of time during the energy transfer is kept at a temperature such that the difference between this temperature and an activation temperature of a chemical reaction that involves the nanoobjects and the gas medium is less than a maximal difference between temperatures of any parts of the nanoobjects during energy transfer;
ii) the device for sorting nanoobjects, further comprises: a component providing that at least some part of the gas medium for at least some (nonzero) period of time during the energy transfer is kept at a temperature such that the difference between this temperature and an activation temperature of a chemical reaction that involves the nanoobjects and the gas medium is less than a maximal difference between temperatures of any parts of the nanoobjects during energy transfer.

40. The apparatus of claim 28, wherein
i) the method further comprises the energy transfer that at least includes an electromagnetic radiation in the frequency range from 100 MHz to 400 THz;
ii) the device for sorting nanoobjects, that further comprises: a component providing the energy transfer that at least includes an electromagnetic radiation in the frequency range from 100 MHz to 400 THz.

41. The apparatus of claim 27, wherein
i) the method further comprises the energy transfer that at least includes transferring energy by a narrow bandwidth electromagnetic radiation with a photon energy at the edge of resonance electron transitions in the nanoobjects in the frequency range from 100 MHz to 400 THz;
ii) the device for sorting nanoobjects, that further comprises: a component providing the energy transfer that at least includes transferring energy by a narrow bandwidth electromagnetic radiation with a photon energy at the edge of resonance electron transitions in the nanoobjects in the frequency range from 100 MHz to 400 THz.

42. The apparatus of claim 28, wherein
i) the method further comprises the energy transfer that at least includes transferring energy from an electrical source by an electrical current selected from the group consisting of: a direct current that provides heat, an alternating current that provides heat, and any combinations thereof;
ii) the device for sorting nanoobjects, that further comprises: a component providing the energy transfer that at least includes transferring energy from an electrical source by an electrical current selected from the group consisting of: a direct current that provides heat, an alternating current that provides heat, and any combinations thereof.

43. A method for sorting nanoobjects (objects with at least one spatial size in the range from 0.05 nm to 500 nm), comprising the steps of: a) providing a contact between an initial mixture that comprises the nanoobjects with different electrical conductivities and a electrical conducting surface of a substance selected from the group consisting of: a solid, a liquid, a soft matter, and any combinations thereof; b) providing a deposition of a material in an electrolyte while driving an electrical current through the said contact at least during some (nonzero) period of time during this deposition with a thickness of the material layer deposited per unit of time on the nanoonobjects dependent on their electrical conductivities until at least some of the nanoonobjects are bonded to the surface with an average strength of this bonding dependent on the nanoobjects electrical conductivities; c) selectively separating mostly the weaker bonded and non-bonded nanoobjects from the surface; and d) obtaining at least one product that comprises the nanoobjects with an average electrical conductivity that is different from the average electrical conductivity of the nanoobjects in the initial mixture.

44. The method of claim 43, wherein the mixture comprises at least one semiconducting carbon nanotube.

45. The method of claim 44, further comprising the steps of: providing the fixed contact by at least one of the means selected from the group consisting of: a mechanical force, a gravitational force, and an inertial force.

46. The method of claim 44, wherein the electrical conducting surface, the material, and the electrolyte comprises at least one chemical element from the group consisting of: a alkali metal, an alkaline earth metal, C, H, Si, As, Ga, In, Sb, Cu, Au, Pd, Pt, Ag, Al, Ni, Co, Fe, Sn, Zn, Hg, Pb, and any combinations thereof.

47. The method of claim 44, wherein the conducting surface of the substance has a shape with a high ratio (≧1.5) of the surface area to the surface area of a flat geometrical figure with the same overall length and width.

48. The method of claim 44, wherein the deposition of the material comprises an electroplating deposition with providing an electrical potential difference in the electrolyte between at least some (nonzero) part of the mixture and at least one other electrode in the electrolyte.

49. The method of claim 44, wherein the separation of the weaker bonded and non-bonded nanoobjects from the surface is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof.

50. The method of claim 44, wherein the weaker bonded carbon nanotubes and non-bonded carbon nanotubes comprises a bigger than average portion of the semiconducting carbon nanotubes.

51. An apparatus, comprising at least one device from the group consisting of:
i) a field effect transistor, a bipolar transistor, a solar cell, a laser, a light emitting diode, a photodiode, an electron source, a device for transforming and radiating electromagnetic fields, an electrical source, a capacitor, a device for surface studies, a computer related device, a device for hydrogen storage, a monitor, a flexible electronic device, a flexible optoelectronic device, an electrical connector, and a thermal connector, comprising any nanoobjects from the product obtained by the method of claim 43; and
ii) a device for sorting nanoobjects, comprising a) a component providing a contact between an initial mixture that comprises the nanoobjects with different electrical conductivities and an electrical conducting surface of a substance selected from the group consisting of: a solid, a liquid, a soft matter, and any combinations thereof; b) a component providing a deposition of a material in an electrolyte while driving an electrical current through the said contact at least during some (nonzero) period of time during this deposition with a thickness of the material layer deposited per unit of time on the nanoonobjects dependent on their electrical conductivities until at least some of the nanoonobjects are bonded to the surface with an average strength of this bonding dependent on the nanoobjects electrical conductivities; c) a component selectively separating mostly the weaker bonded and non-bonded nanoobjects from the surface; and d) a component obtaining at least one product that comprises the nanoobjects with an average electrical conductivity that is different from the average electrical conductivity of the nanoobjects in the initial mixture.

52. The apparatus of claim 51, wherein the mixture comprises at least one semiconducting carbon nanotube.

53. The apparatus of claim 52, wherein
i) the method further comprises the steps of: providing the fixed contact by at least one of the means selected from the group consisting of: a mechanical force, a gravitational force, and an inertial force;
ii) the device for sorting nanoobjects, that further comprises: a component providing the fixed contact by at least one of the means selected from the group consisting of: a mechanical force, a gravitational force, and an inertial force.

54. The apparatus of claim 52, wherein
i) the method further comprises the electrical conducting surface, the material, and the electrolyte that comprises at least one chemical element from the group consisting of: a alkali metal, an alkaline earth metal, C, H, Si, As, Ga, In, Sb, Cu, Au, Pd, Pt, Ag, Al, Ni, Co, Fe, Sn, Zn, Hg, Pb, and any combinations thereof
ii) the device for sorting nanoobjects, further comprises: the electrical conducting surface, the material, and the electrolyte that comprises at least one chemical element from the group consisting of: a alkali metal, an alkaline earth metal, C, H, Si, As, Ga, In, Sb, Cu, Au, Pd, Pt, Ag, Al, Ni, Co, Fe, Sn, Zn, Hg, Pb, and any combinations thereof.

55. The apparatus of claim 52, wherein
i) the method further comprises the conducting surface of the substance that has a shape with a high ratio (≧1.5) of the surface area to the surface area of a flat geometrical figure with the same overall length and width;
ii) the device for sorting nanoobjects, that further comprises: the conducting surface of the substance that has a shape with a high ratio (≧1.5) of the surface area to the surface area of a flat geometrical figure with the same overall length and width.

56. The apparatus of claim 52, wherein
i) the method further comprises the deposition of the material that comprises an electroplating deposition with providing an electrical potential difference in the electrolyte between at least some (nonzero) part of the mixture and at least one other electrode in the electrolyte;
ii) the device for sorting nanoobjects, further comprises: a component providing the deposition of the material that comprises an electroplating deposition with providing an electrical potential difference in the electrolyte between at least some (nonzero) part of the mixture and at least one other electrode in the electrolyte.

57. The apparatus of claim 52, wherein
i) the method further comprises the separation of the weaker bonded and non-bonded nanoobjects from the surface that is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof;
ii) the device for sorting nanoobjects, further comprises: a component providing the separation of the weaker bonded and non-bonded nanoobjects from the surface that is conducted by using at least one process from the group consisting of a separation by a gas flow, a separation by a liquid flow, a separation by an ultrasonication, a separation by an electrostatic force, a separation by a magnetic force, a separation by a gravitational force, a separation by an inertial force, a separation by dissolving other components, a separation by evaporating other components, and by any combination thereof.

58. The apparatus of claim 52, wherein
i) the method further comprises that the weaker bonded carbon nanotubes and non-bonded carbon nanotubes comprises a bigger than average portion of the semiconducting carbon nanotubes;
ii) the device for sorting nanoobjects, further comprises: a component providing that the weaker bonded carbon nanotubes and non-bonded carbon nanotubes comprises a bigger than average portion of the semiconducting carbon nanotubes.
